(19) United States
(12) Patent Application Publication
(10) Pub. No.: US 2017/0095681 A1
(43) Pub. Date: Apr. 6, 2017

(54) ADJUSTABLE FACIAL CONFORMING FACE MASK

(71) Applicant: BALBOA MANUFACTURING COMPANY, LLC, San Diego, CA (US)

(72) Inventor: John SMALLER, San Diego, CA (US)

(73) Assignee: BALBOA MANUFACTURING COMPANY, LLC, San Diego, CA (US)

(21) Appl. No.: 15/380,886

(22) Filed: Dec. 15, 2016

Related U.S. Application Data
(63) Continuation of application No. 14/221,076, filed on Mar. 20, 2014, now abandoned.
Application No. 14/221,076 is a continuation-in-part of application No. 12/983,839, filed on Jan. 3, 2011, now abandoned.

(51) Int. Cl. A62B 18/02; A41D 13/05; A41D 13/11; A62B 23/02; A62B 18/08

(52) U.S. Cl. CPC A62B 18/02; A62B 23/025; A62B 18/084; A41D 13/1107; A41D 13/1161; A41D 13/0512; A41D 2600/102; A41D 2300/32

(57) ABSTRACT

An adjustable face mask having a body conforming substantially to the facial structure of a wearer. The face mask is provided with a neck protector and removable filter and with a strip of fabric designed to push air down to the sides of the wearer's face in order to eliminate fogging of the wearer's goggles. The face mask can optionally provide neck protection with a descending neck member.

### RELATED APPLICATIONS INFORMATION

The present application is a continuation of U.S. patent application Ser. No. 14/221,076, filed Mar. 20, 2014, entitled “ADJUSTABLE FACIAL CONFORMING FACE MASK”, which is a continuation-in-part of U.S. patent application Ser. No. 12/983,839, filed Jan. 3, 2011, entitled “ADJUSTABLE FACIAL CONFORMING FACE MASK”, and the entire contents of each of the aforementioned documents are incorporated by reference herein.

### BACKGROUND OF THE INVENTION

Field of the Invention

The current invention relates generally to face masks and face coverings. More specifically it relates to face masks that provide continuous air filtration, face and neck protection and warmth particularly while the wearer is moving at high speeds such as riding on a motorcycle, skiing, and participating in various motorsports.

Prior Art

It has become ever more popular in recent years for young and older people alike to ride motorcycles. Many motor & power sport enthusiasts enjoy multiple activities from street-bikes to ATVs, off-road bikes, side-by-sides and snowmobiles.

While these sports bring the enthusiast closer to nature, they of necessity tend to introduce the rider to various elements including dust, debris, flying rocks, sand, insects, cold wind, snow and other common hazards. In states requiring helmets and for those who choose to wear them, some helmets incorporate face guards for protection from large objects, however they do little or nothing to filter out fine particulate matter common in dusty or sandy environments. In addition, other helmets, such as those worn by riders of snowmobiles and dirt bikes, while covering the lower face, allow for greater airflow and thus, expose the rider to cold and other hazards.

Conversely, open-faced helmets provide no face protection whatsoever to the rider that can result in some serious impacts with the rider's face by bugs and road debris in addition to providing no protection from fumes emitted from automobiles on the road. Despite this, open-faced helmets are often preferred for various reasons, including style and enhanced visibility.

Other sports such as skiing, snowboarding, snowmobiling, and other cold weather outdoor sports have been popular for years, pushing innovation in technical outdoor gear. Innovation is necessary to address painful frostbite, a common occurrence in many of these sports.

For skiers, snowmobilers, bike riders, motorcycle riders and other motorsport enthusiasts wearing helmets, full-face helmets tend to fog quickly, especially when employed with the use of goggles. This most often occurs due to the heavy breathing of the user, and/or temperature differentials between the interior of such shields and the atmosphere. Further, most such shields afford no form of air filtration to protect the breathing and eyes of the rider in areas prone to dust, smoke, or pollution.

Face mask and face protection devices that provide face coverage as well as air filtration do so by including an insert on the inner surface of the mask for installation and removal of standard dust masks not provided with the device initially. This of course requires the user to purchase extraneous products to achieve the desired face protection and air filtration offered by the mask. In addition, many of these existing face masks cause additional fogging issues, and, while protecting from wind and dust, do not protect against other air-born contaminants or diesel fuel, a common hazard of street-riding.

As such, it is seen that there is a need for a face-mask that provides a balance of protection, warmth, anti-fogging and air filtration and that may be used in conjunction with certain full-face helmets or alone with the use of goggles or other eyewear. Such a device should be wearable by many types of riders and sports participants to protect their faces from both weather and from impacts which occur at medium to high speeds with bugs and debris and the like.

### SUMMARY OF THE INVENTION

The present invention provides face and neck protection by means of semi-soft malleable material, such as neoprene, or any other semi-soft malleable material which is face conforming, adjustable to the wearer's nose, having an interior surface adapted to be gentle to the user's skin and having an exterior surface configured to withstand the elements. The material has a thickness and density to afford insulation from wind chill as well as to form a pad against potential impacts from road debris and such other airborne hazards as insects and gravel.

The interior surface is fitted directly against the users face in the as-used position and using the preferred material and its elastic nature, will generally conform to the surface of the face. In a particularly preferred mode, there is a replaceable filter engaged between the interior surface of the mask in the area of the nose and mouth of the user. In the preferred mode of the device, the filter is formed of a bamboo/carbon-fiber material as this is naturally hypoallergenic and will not cause irritation to the skin of the user, however the material of the filter may be made of other materials depending on the purpose for which the filter is being used.

A means to securely engage the device to the user in a preferred mode, is provided using hook and loop type fastener material, or other fasteners, such as snaps, which are positioned on straps. The straps have a length sufficient to extend around the neck to the back of the user's head with appreciable overlap to allow for secure engagement into the head in the as-used position.

To assist the user in breathing through the device there is provided, an array of apertures positioned inline with and proximate to the nose/mouth area of the user and the device. The quantity, orientation, and diameter of the apertures are of such construction to yield an aggregate area of air passage to supply the user with sufficient air supply for breathing. In a preferred mode of the device, the apertures are formed in spherical shape having corresponding circular openings of equal diameter on the interior and exterior of the mask.

In one embodiment, the vertical extent of the device begins at the bridge of the nose and continues to just below the chin. This embodiment encompasses full coverage of the nose, mouth, and cheeks with the securement strap extending around the neck.

In another embodiment, the device extends from the bridge of the nose to just below the shoulder line of the wearer, offering full frontal neck coverage as well, a desired embodiment in cold-weather sports.

In all embodiments, there is a thin semi-rigid malleable strip of material extending around the bridge area of the nose at the upper most interior section of the device. This allows the user to adjust the fit of the device at the nose, allowing for a more custom fit. The thin semi-rigid malleable strip is encased in neoprene or other fabric. In one embodiment this fabric forms a sleeve around the strip. The strip is then affixed to the device at its distal end and center. There is also a strip of material called a ledge or lip, which is attached at one side to the device and contours the edge of the device from just below the nose on the right side to the left side. The ledge can be formed of neoprene and is attached to the interior of the mask by the upper edge part of the ledge hangs over the semi-rigid malleable strip and extends partially along the wearer's upper cheekbones to the right and left of the nose. This additional strip of fabric functions to push air down and out along the sides of the wearer's face, eliminating fogging due to the wearer's breath.

With respect to the above description, it is to be understood that the invention is not limited in its application to the details of operation of the invention nor the arrangement of the components or steps in the method set forth above or in the following descriptions or in the illustrations in the drawings. The various methods of implementation and operation of the disclosed device herein, are capable of other embodiments and of being practiced and carried out in various ways that will be obvious to those skilled in the art once they review this disclosure. Also, it is to be understood that the phraseology and terminology employed herein are for the purpose of description and should not be regarded as limiting.

Those skilled in the art will appreciate that the conception upon which this disclosure is based may readily be utilized as a basis for designing similar face shielding devices adapted to conform to the user's facial structure and for carrying out the several purposes of the present invention. Therefore, the objects and claims herein should be regarded as including such equivalent constructions, steps, and methodology insofar as they do not depart from the spirit and scope of the present invention.

It is an object of the present invention to provide a user with protection and warmth of the nose/mouth region of the face as well as for the neck when exposed to cold or wind.

It is another object of the invention to provide a means to filter incoming air via a removable filter.

It is yet another object of the invention to maintain a close and secure engagement about the bridge of the nose.

It is still another object of the invention to provide a means for pushing and/or directing air away from the wearer's eyes in order to eliminate fogging of the wearer's goggles. When the user of the device breaths through their nose or mouth air is directed down to the right and left of the nose and mouth rather than upward toward the eyes.

These together with other objects and advantages will become subsequently apparent in the details of the adjustable facial conforming facemask as more fully hereinafter described and claimed, reference being had to the accompanying drawings forming a part thereof.

### BRIEF DESCRIPTION OF THE FIGURES

FIG. 1 depicts a side view of one embodiment of the device with neck protection, straps, air intake apertures, and filter snap locks.

FIG. 2 shows the exterior surface of the invention depicted in FIG. 1.

FIG. 3 shows the interior of the surface of the invention depicted in FIG. 1 and showing the interior corresponding snap fits for engagement with the filter.

FIG. 4 depicts another embodiment of the device providing face protection only, also showing straps, air apertures, and filter engagement snap fits.

FIG. 5 shows the exterior surface of the invention as depicted in FIG. 4.

FIG. 6 shows the interior of the face mask as depicted in FIG. 4 showing the interior corresponding snap fits for engagement with the filter.

FIG. 7 shows the interior surface of the invention with the nose/mouth filter engaged in one embodiment of the invention providing neck protection.

FIG. 8 shows the interior surface of the invention with the nose/mouth filter engaged in one embodiment of the device providing face protection only.

FIG. 9 shows a cross-sectional depiction of the spherical apertures with parallel walls allowing the breather to communicate air through the face apertures and the filter.

FIG. 10 shows a close-up view of the fabric ledge attached to the upper most periphery of the interior of the face mask and showing the way in which air is forced down and out to the sides of the wearer's face to prevent fogging.

FIG. 11 shows the as used position of the device with a neck protector extension as described in FIG. 1.

FIG. 12 shows the as used position of the device without a neck protector extension as described in FIG. 4.

### DETAILED DESCRIPTION OF THE PREFERRED EMBODIMENTS OF THE INVENTION

Now referring to drawings in FIGS. 1-12, wherein similar components are identified by like reference numerals, there is seen in FIG. 1 a side view of one preferred mode of the body 11 of the device 10 having a descending neck protector extension 18 hanging in front of, and spaced away from the surface of a user's neck. The extension 18 is especially preferred because it provides a means to shield the neck of the user from impact and cold weather if the device 10 is worn by a user such as a motorcycle rider, mountain bike rider, skier or other power sport participant.

When the device 10 is employed by the user in the as-used position, the side straps 16 are wrapped about a users neck and engaged. The straps 16 are formed of the same material as the body 11 and are also elastic in nature and thus when engaged to each other and around the user's neck, provide a means to bias the body of the device 10 against the face of the user.

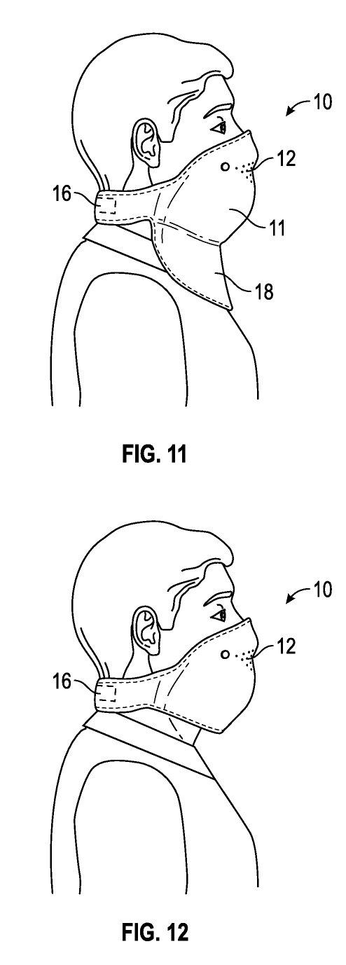

Depicted in FIG. 1 by dashed lines is one possible means of engagement such as sewn-in hook and loop fastener 17 material. Although not pictured, such engagement of the side straps 16 may possibly be snap fits or other such means of engagement and should not be considered limited by the depiction in the figure. The profile of the device 10 is seen (as in FIG. 11) wherein the body 11 is configured to follow and conform the profile as generally seen in a human head and face, more specifically to follow and conform to the contours of the human nose and mouth. Employing a material with elastic qualities such as neoprene, which is initially formed to somewhat conform to the user's face by sewing or forming and heating, allows the material to slightly stretch and tend to hug the user's face when in the as-used position of FIG. 11.

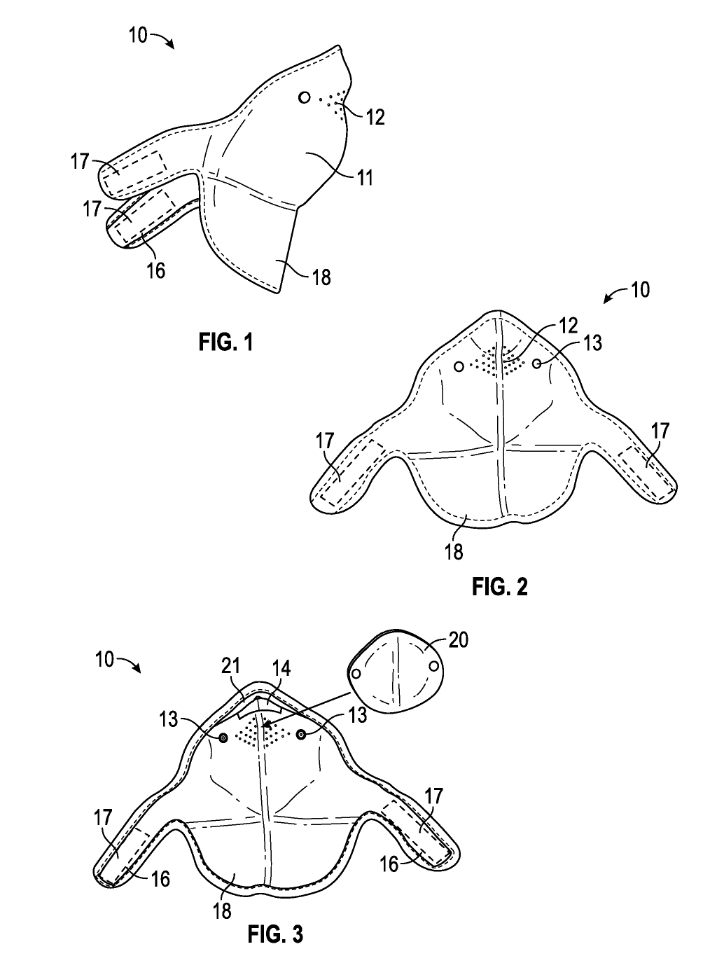

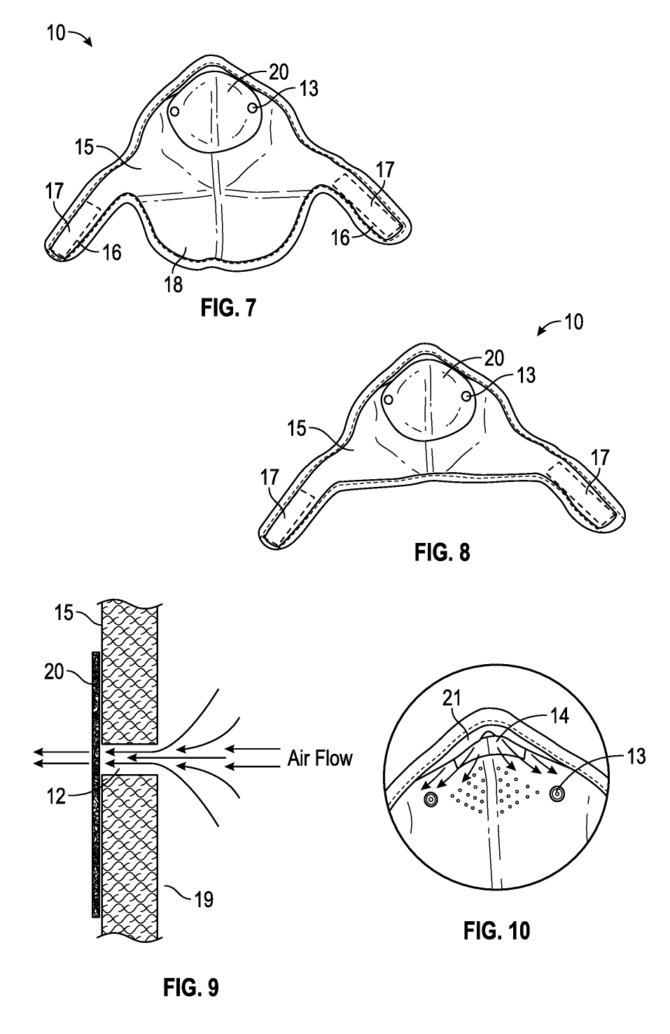

Shown in FIG. 2 is a view of the exterior surface of the body 11 of device 10. The air apertures 12 are located generally about the nose and mouth region of the device 10 and positioned to align with the nose and mouth of the user when the device 10 is in the as-used position. An air filter 20 can be affixed to the device 10. The air filter 20 can be made of bamboo fibers, carbon and electrostatically charged polypropylene fibers in addition to other known flat fibrous materials. One means for engagement of an air filter 20 (FIG. 7) to the invention 10 is depicted as snap fits 13. Similarly, this means of engagement should not be limited to what is depicted but could also be hook and loop fasteners 17 or other fasteners of the like. Snap fits 13 are shown merely for demonstrative purposes.

The filter is useful in that it provides additional protection from biting cold wind but also protects the wearer from air-born contaminants, pollution, fumes from the road, dust, sand and liquids. The bamboo portion of the filter is also anti-bacterial which reduces odors and bacteria from forming. The filter is also replaceable and easily interchangeable.

Shown in FIG. 3 is a view of the interior surface of the body 11 of the device 10. The malleable nose piece adjusting member 14 is engaged to the body 11 either in a pocket or by adhesive, or by other means of engagement. The nose piece 14 is covered by a layer of fabric or other material. The fabric or other material can be formed as a pocket that surrounds the nose piece 14 and allows it to be attached to the body 11. The fabric or other material protects the bridge of the user's nose from the metal of the nose piece 14 which can be cold or hard on the user's nose. The nose piece is engaged to the body 11 at a position traversing over the top surface of a user's nose when said device is in said as-used position. The nose piece 14 is made of a malleable and resilient material and tends to maintain its shape once adjusted by the user to a user's specific nose bridge. It will withstand repeated use, and provides a user-adjustable means to shape the body 11 at a portion of the body 11 where it crosses the user's nose to better conform the body 11 to hug the user's skin adjacent to and over the nose when in the as-used position. The nose piece 14 may be formed of any material which is bendable to shape and can do so repeatedly such as metal or plastic.

Shown in FIG. 3 is a strip of neoprene or other material referred to as a ledge or lip 21 sewn into the seam of the upper peripheral portion of the device 10. The ledge 21 is located at the upper edge of the body 11 just above the nose piece 14. The ledge 21 is attached to the body of the mask 11 only by stitching along the top of the ledge 21. The ledge 21 is configured to push air from the user's breath down and out to the side of the mask as depicted in FIG. 10. The ledge 21 may be made of the same material as the body 11 of device 10, but should not be limited to that material only. In one embodiment the ledge 21 is configured to commence just to the lower left of the user's nose and form a arced angle which dips in at the bridge of the nose and then extends out to another angle ending below the right side of the user's nose. The distal ends of the ledge 21 are narrower than the middle of the arc and the area at the center of the ledge 21 just below the bridge of the nose is narrower than the arcs on either the right or left side of the user's nose. In this configuration the ledge 21 hangs partially over the nose piece 14. In this configuration when the user breathes from their nose, the air that would normally be forced upward is caught in the gap and directed downward and to the right and left of the user's nose and mouth as well as out the apertures 12, creating maximum air flow away from the wearer's face. The ledge 21 essentially forces air away from the user's eyes. In the instance where a user is wearing goggles, glasses or other eyewear, this eyewear does not become fogged or have condensation issues as the air and hot breath is forced in the opposite direction. This eliminates the need to take off one's eyewear to wipe off the lenses during participation in strenuous activities. The benefits of this improvement extend far beyond convenience. If worn during tactical operations, this time saving improvement could be life saving.

If a user decides that air filtration is needed then a filter 20 is engaged onto the interior surface 15 adjacent to the air apertures 12 as depicted in FIGS. 7 and 8. Again, the engagement of the air filter 20 is depicted by snap fits 13 but should not be considered limiting. In the preferred embodiment of the device 10 the filter 20 is of bamboo and carbon fiber construction but can take on many other modes. Carbon filtering uses a bed of activated carbon to remove contaminants and impurities using chemical absorption. The manufactured carbon cloth can filtrate bacteria, dust, micro-granules and organic poisonous gases effectively because of the large surface area of each carbon particle, allowing contaminants the maximum possible exposure to the active sites within the filter media. Other filters, such as those made of polypropylene are beneficial to filter out dust and debris while still allowing for maximum breathability. Polypropylene filters are a type of electrostatic filter in which fibers are rubbed together, creating a positively and negatively charged fiber, which are then constructed into a nonwoven felt, providing the filter material. The electrically charged material attracts and binds to any material that passes through it. Filters made of bamboo fibers have the additional benefits of being anti-bacterial, which reduces odors due to repeated use and are environmentally friendly by using sustainable materials.

Referring back to the air apertures 12 there is seen in FIG. 9 a cross-section of their communication through the device 10. Air enters from the exterior surface 19 and communicates along the cross-sectional area to exit at the interior surface 15 and vice versa, enabling the user to breath and speak easily. The apertures 12 also allow the air to escape so that it is not trapped in the device and for the eyewear or create condensation in the interior of the device.

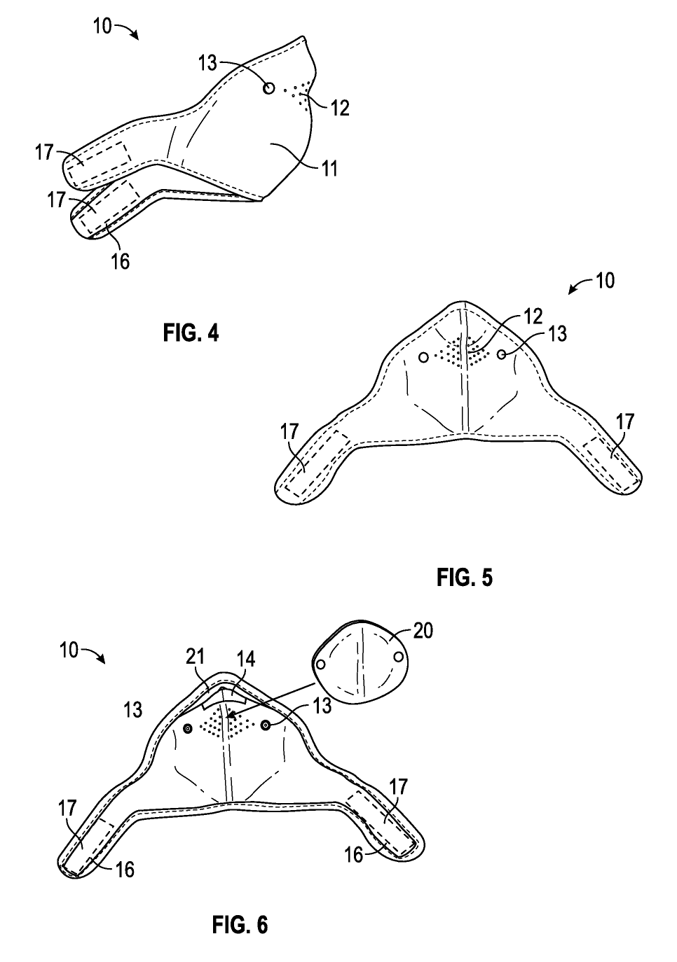

FIGS. 11 and 12 depict the as-used position of the device 10 in all modes as described in FIGS. 1 and 4. The user fits the device 10 over their face positioning the contoured portion forming the nose and mouth over their nose and mouth and in line with the air apertures 12. Then the straps 16 are pulled snugly around the back of the head and engaged firmly about the neck using means for fastening such as the depicted hook and loop fabric 17 or other means of fastening such as snaps or buttons. FIG. 11 depicts a device 10 with a neck portion 18 that is useful for cold weather wear of additional protection from debris. FIG. 12 depicts a device 10 without the neck protection 18 allowing for more flexibility. Breathing by the user is as normal whether or not the filter 20 is engaged since air passage and communication to the nose and mouth of the user is aided by the airstream from the apertures 12. However the filter 20 is preferred especially when worn on a moving vehicle such as a motorcycle as it prevents particulate and liquid from reaching the user's nose and mouth. Further, it provides a chamber in front of the user's nose and mouth wherein air from multiple apertures 12 is communicated to the chamber area thereby allowing the user to breath from the single and larger chamber formed by the filter 20 instead of individual apertures 12.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A face mask apparatus configured for covering a user's face when worn in an as-used position, comprising:
a body, said body dimensioned to cover the user's nose and mouth and chin when positioned against their face in an as-used position;
means to engage said body to said as-used position with an interior surface of said body in a contact with said user's face and an exterior surface of said body opposite said interior surface;
a malleable nose piece covered with fabric engaged to said body at a position traversing over the top surface of a user's nose when said device is in said as-used position;
a ledge at the upper peripheral portion of the device configured to push air down and out the sides of the mask;
a plurality of apertures communicating through said body in a region of said body aligned with said user's face and nose when said device is in said as-used position;
said apertures providing means to communicate air to said user when said device is in said as-used position; whereby said device worn in said as-used position, provides a shield to said face of said user who can breath through said apertures.

2. The face mask of claim 1 additionally comprising:
a filter, said filter positioned upon said interior surface and aligned with said apertures;
said filter receiving air from a plurality of said apertures and forming a chamber whereby said user can breath through their nose or mouth and inhale air from a plurality of said apertures from said chamber.

3. The face mask of claim 1 additionally comprising:
a nose piece bendable by said user to a fit shape to conform to a diameter and angled sides of their nose; and
said nose piece in said fit shape, providing means to maintain said body to conform with a contour of said user's nose defined by said angled sides, and in a contact with said sides of said user's nose.

4. The face mask of claim 2 additionally comprising:
a malleable member engaged to said body at a position traversing over the top surface of a user's nose when said device is in said as-used position;
said member bendable by said user to a fit shape to conform to a diameter and angled sides of their nose; and
said member in said fit shape, providing means to maintain said body to conform with a contour of said user's nose defined by said angled sides, and in a contact with said sides of said user's nose.

5. The face mask of claim 1 additionally comprising:
a shield portion, extending below a chin of said user to a distal end, said distal end spaced from, and in front of, said user's neck.

6. The face mask of claim 2 additionally comprising:
a shield portion, extending below a chin of said user to a distal end, said distal end spaced from, and in front of, said user's neck.

7. The face mask of claim 1 additionally comprising:
a neck protector, extending below a chin of said user to a distal end, said distal end spaced from, and in front of, said user's neck.

8. The face mask of claim 1, wherein the ledge is configured to commence just to the lower left of the user's nose and form an aced angle which dips in at the bridge of the nose and then exends out to another angle ending below the right side of the user's nose.

9. The face mask of claim 1, wherein the ledge is configured to push the air from the user's breath down the sides of the face, out the apertures and not allow the air to escape upward toward the eyes.

10. The face mask of claim 1, wherein the fabric covering the nose piece is a pocket.

11. The filter or claim 1 constructed of activated carbon to remove contaminants and impurities using chemical absorption.

12. A face mask comprising:
a body with an interior and exterior surface configured to cover the user's lower face when worn;
a means to engage said body to the users face;
a nose piece attached to the interior of the body at a position traversing the top surface of a user's nose when worn;
a ledge at the upper peripheral edge of the device above the nose piece; and
a plurality of apertures in the body aligned with the user's nose and mouth.

13. The face mask of claim 12 additionally comprising:
a filter, said filter positioned upon said interior surface and aligned with said apertures;
said filter receiving air from a plurality of said apertures and forming a chamber whereby said user can breath through their nose or mouth and inhale air from a plurality of said apertures from said chamber.

14. The filter of claim 13 which is a polypropylene electrostatic filter.

15. The face mask of claim 12 additionally comprising:
a nose piece bendable by said user to a fit shape to conform to a diameter and angled sides of their nose; and
said nose piece in said fit shape, providing means to maintain said body to conform with a contour of said user's nose defined by said angled sides, and in a contact with said sides of said user's nose.

16. The face mask of claim 12 additionally comprising:
a neck protector, extending below a chin of said user to a distal end, said distal end spaced from, and in front of, said user's neck.
